(19) United States
(12) Patent Application Publication
(10) Pub. No.: US 2002/0004093 A1
(43) Pub. Date: Jan. 10, 2002

(54) Low calorie humectant

(76) Inventors: Milda Embuscado, Cockeys Ville, MD (US); Austin Cheryl, Highland, IN (US); Arbas Ibrahim, Munster, IN (US)

Correspondence Address: BIERMAN MUSERLIAN AND LUCAS, 600 THIRD AVENUE, NEW YORK, NY, 10016

(21) Appl. No.: 09/782,803

(22) Filed: Feb. 14, 2001

Related U.S. Application Data
(60) Provisional application No. 60/182,718, filed on Feb. 15, 2000.

(51) Int. Cl. A23L 1/03

(52) U.S. Cl. 426/548; 426/658; 426/549

(57) ABSTRACT

The low calorie humectant is made from a humectant, erythritol and water. The addition of erythritol provides a synergistic increase in water retention to the humectant. A food product is formed by first combining erythritol with the humectant or the low molecular weight carbohydrate such as glycerol, sucrose, dextrose or fructose and water to form the low calorie humectant. Then, the other food ingredients are combined with the low calorie humectant.

### BACKGROUND OF THE INVENTION

1. Technical Field

The present invention relates to food and, more specifically, to a low calorie humectant made from a blend of erythritol and one or more humectants or carbohydrates.

2. Related Art

Humectants are used in food to promote retention of water, thereby preventing or lessening the rate at which the food becomes dry, stale and unacceptable. Typically, low molecular weight carbohydrates such as fructose and glycerol are used as humectants. A problem associated with such humectants is that they add unwanted calories to the food product.

Erythritol is a naturally-occurring polyol sweetener which has recently become available in large quantities. The use of erythritol in food as a non-caloric sweetener is known. Erythritol is 60% as sweet as sucrose but is not metabolized by humans. Erythritol has also been suggested as a fat replacer because it mimics the mouth feel of fat.

Erythritol has also been taught for use as an anti-cariogenic agent for use in food, tooth paste and mouthwash, see European Patent Application Publication No. 800,823. Erythritol is also known to have no humectant properties.

### SUMMARY OF THE INVENTION

It has been discovered that erythritol, in combination with one or more humectants, increases the water retention properties of the humectant. This is truly surprising and unexpected because erythritol has no humectant properties. Thus, the combination of erythritol with a humectant to increase the water retention properties of the humectant is truly synergistic.

Increasing water retention in a food product but with a low water activity also has the beneficial effect of increasing shelf life and improves the texture of the food.

Furthermore, because conventional humectants such as fructose add calories to the food in which it is used, the combination of erythritol with such conventional humectants allows for a reduction of the caloric content of the food.

A further advantage provided by the use of erythritol is the promotion of better oral health. Erythritol is known to be non-cariogenic. Thus, good dental hygiene is fostered by the use of erythritol in the food.

Broadly, the low calorie humectant of the present invention comprises erythritol and one or more humectants. Broadly, the low calorie humectant of the present invention is made by forming an aqueous blend of erythritol, one or more humectants, and water. A food product, especially a baked good, employs the low calorie humectant of the present invention by combining the aqueous blend with the other components and then forming the food product.

As will be appreciated, conventional food formulations contain ingredients which function as humectants and also have other purposes. For example, sugar, fructose, or other low molecular weight carbohydrates, are often employed primarily as a sweetener in baked goods. As is known, such sweeteners also function as a humectant. In such a food, the erythritol is blended with water and one or more carbohydrates to make the low calorie humectant of the present invention. Then, the low calorie humectant of the present invention is combined with the other ingredients in the food product. No additional humectant is needed to form the low calorie humectant of the present invention. It has been found that the erythritol enhances the humectant properties of the other carbohydrates in the food formulation. In other words, erythritol itself acts as a humectant so long as there are one or more low molecular weight carbohydrates present and the erythritol is mixed with water and the carbohydrates first before mixing with the other ingredients in the food formulation.

### BRIEF DESCRIPTION OF THE DRAWINGS

FIG. 1 illustrates the synergistic properties of the present invention; and

FIG. 2 illustrates the water sorption properties of three different blends according to the present invention.

### DETAILED DESCRIPTION OF THE INVENTION

The low calorie humectant of the present invention preferably comprises one or more humectants and an effective amount of erythritol wherein the amount of erythritol is effective to increase the water retention properties of the humectant. More preferably, the amount of erythritol employed is about 5% to about 95% based on the dry solids weight of the low calorie humectant. Good results have been obtained when the amount of erythritol is about 50% based on the total weight of the low calorie humectant.

Any conventional source of erythritol can be used in the present invention. Good results have been obtained with C*ERIDEX available from Cerestar USA, Inc.

The one or more humectants used in the low calorie humectant of the present invention is any conventional carbohydrate humectant or combination of humectants. In other words, the present invention can include one or more humectants with the erythritol. The erythritol increases the humectant properties of the humectants. Suitable carbohydrate humectants for use in the present invention include glycerol, propylene glycol, fructose, sucrose, dextrose, high fructose corn syrup, and other polyols.

Suitable other polyols (not erythritol) include sorbitol, xylitorl, maltitol, lactitol and isomaltitol. When these other polyols are employed, they should not exceed about 95% by dry solids weight low calorie humectant.

As is known, in food formulations, low molecular weight carbohydrates such as sugar, e.g. sucrose, dextrose and fructose, function primarily as sweeteners with the additional effect of acting as humectants. In food formulations, the erythritol can function with the low molecular weight carbohydrates that are normally employed in the formulation as a sweetener to act as the low calorie humectant of the present invention provided the carbohydrate and erythritol are mixed with water to form a blend and then the blend is mixed with the other components in the food formulation.

In order to make the present invention, a blend of water, erythritol and one or more humectants are formed where the amount of water is about 50% to about 120% based on the total dry solids weight of the blend. More preferably, the amount of water present is about 90% to about 110% by dry solids weight of the total blend. As will be appreciated, where the humectant already contains water, such as a high fructose corn syrup, no additional water is necessary. Also, where the food product to which the low calorie humectant of the present invention is to be employed, has water in its formulation, then that water can be used to blend the low calorie humectant, no additional water is necessary.

The step of blending is done in a conventional manner using conventional equipment. One or more humectants can be combined with erythritol and then added to water or, alternatively, both the humectants and erythritol are blended with water either one at a time or together. After forming the blend, the aqueous blend is recovered and combined with the other components of the food product or stored for later use.

To form the food product of the present invention, a blend is formed of water, humectant or the low molecular weight carbohydrate employed in the food product, and erythritol along with any other water soluble carbohydrate in the formulation of the food product. Thus, a solution is formed with the water component, the erythritol, the humectant/low molecular weight carbohydrate, and any other water soluble component in the food formulation. After the solution has been completely mixed together, the other components are added to the solution to complete the formulation of the food product.

When using erythritol in a food formulation which contains a low molecular weight carbohydrate, no additional humectant needs to be added, provided the low molecular weight carbohydrate has some water retention capability.

It is critical that the low molecular weight carbohydrate be combined with the erythritol and water first and then the other ingredients added to formulate the food.

After all the ingredients have been combined, the food product is further processed. For example, for a baked good, the water is combined with the erythritol, the sugar, typically sucrose, dextrose, or high fructose, and flour. Then the other ingredients are added to form a dough or batter which is subsequently baked in a conventional way to obtain the baked good.

Suitable food products which can be made in accordance with the present invention include granola, power/health bars, fruit roll ups, brownies, cakes, fruit candies, muffins, and the like.

These and other aspects of the present invention may be more fully understood by reference to one or more of the following examples.

### EXAMPLE 1

This example illustrates forming the low calorie humectant of the present invention and the synergistic properties of the low calorie humectant of the present invention compared to a conventional humectant.

To form the low calorie humectant of the present invention, the following components were mixed together.

TABLE I

| | Amount |
|---|---|
| Component | (grams) |
| Erythritol | 500 |
| Glycerol (humectant) | 500 |
| Water | 1000 |

Mixing of the components in Table I above was conducted by dissolving gylcerol in water and then adding the erythritol. This was then mixed thoroughly to dissolve the erythritol completely before adding the other ingredients.

The mixture was then exposed to different relative humidities until equilibrium was reached. The amount of moisture of each sample equilibrated at each relative humidity was determined. Pure erythritol and pure glycerol were also tested in the same way.

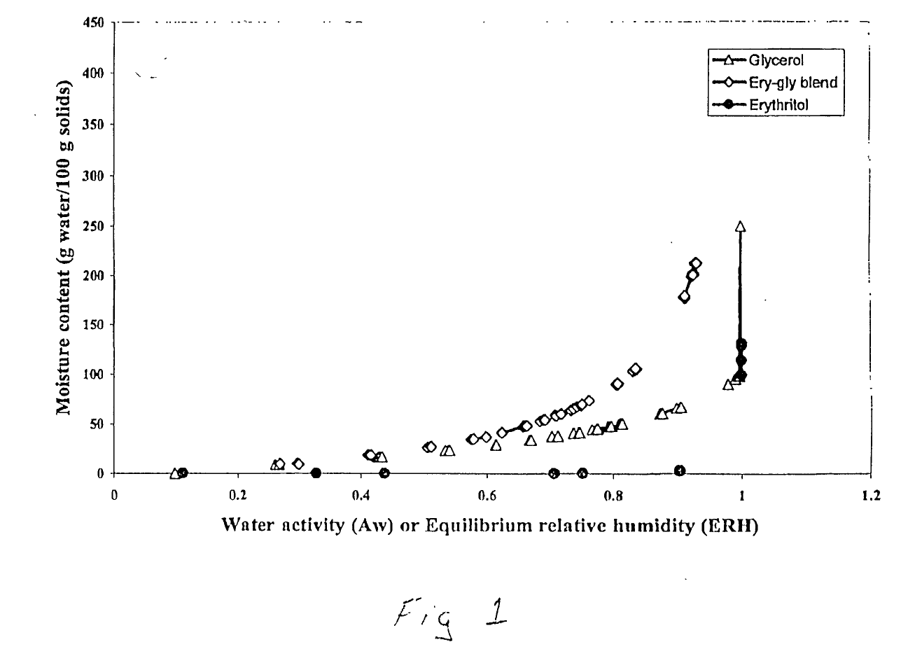

Moisture content (dry basis) was plotted against water activity or equilibrium relative humidity for the blend, pure erythritol and pure glycerol. Such a plot is referred to as a water sorption isotherm. The results are reported in FIG. 1.

As shown therein, the water retention measured along the Y-axis shows that erythritol has no humectant properties and that the combined glycerol and erythritol has far superior water retention capabilities to glycerol alone. This demonstrates the truly synergistic properties of the low calorie humectant of the present invention. FIG. 1 illustrates the water sorption isotherms of erythritol (C* Eridex 16951), glycerol and erythritol (C* Eridex 16951)-glycerol blend.

The water sorption isotherms were measured by the galvimetric method or by using a water activity meter. Each is conventional and were performed in a conventional manner.

### EXAMPLE 2

This example illustrates the calorie reduction obtained with the present invention.

The calorie content of glycerol and a 1:1 mix of glycerol and erythritol are reported in Table II below.

TABLE II

| Component | Kcal per gram |
|---|---|
| Glycerol | 4.32 |
| Glycerol-erythritol mix (1:1) | 2.26 |

These values were calculated using available literature and the accepted caloric values for glycerol and erythritol.

As can be seen, the present invention provides about a 50% reduction in calories.

### EXAMPLE 3

This example illustrates the humectant properties of erythritol with other conventional humectants.

Three blends of erythritol with other known humectants were tested alone with erythritol for water retention capability. The three blends are listed in Table III below.

TABLE III

| Low Calorie Humectant Composition | Amount (grams) |
|---|---|
| Erythritol | 100 |
| Sucrose | 100 |
| Erythritol | 100 |
| Fructose | 100 |
| Erythritol | 100 |
| Dextrose | 100 |

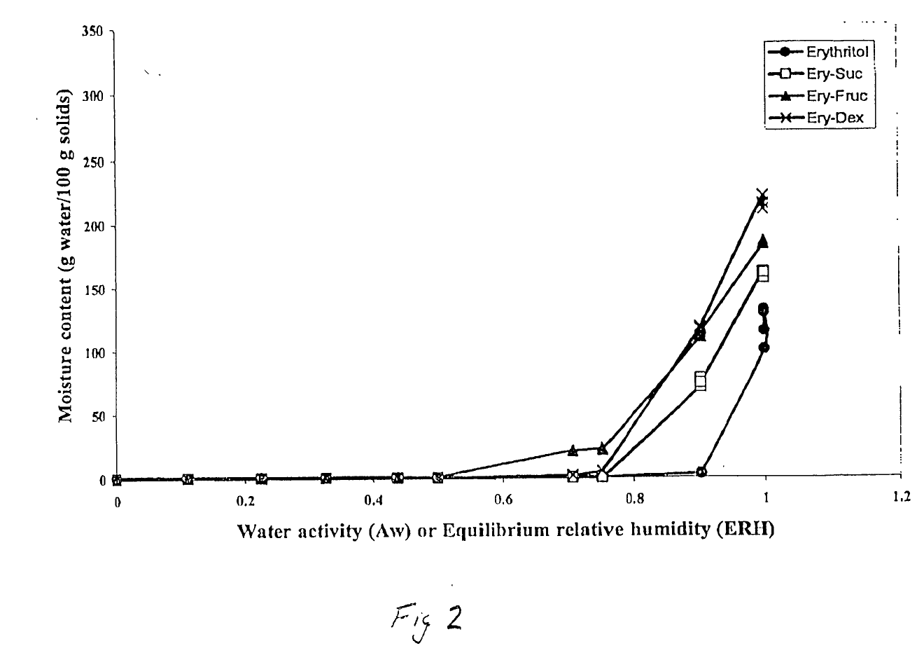

The results are reported in FIG. 2. Each blend was made in the same manner as in Example 1 and the water sorption isotherms were plotted in the same way as Example 1 above. FIG. 2 illustrates the water sorption isotherms of erythritol (C* Eridex 16951), erythritol-sucrose, erythritoi-fructose and erythritol-dextrose blends.

As shown in FIG. 2, the low calorie humectant of the present invention shows humectant properties while erythritol alone has none.

### EXAMPLE 4

This example illustrates making a Granola bar using the low calorie humectant of the present invention. The formulation of the Granola bar is shown in Table IV below.

TABLE IV

| Ingredients | Amount, percent |
|---|---|
| Granola (18% sugar) | 34 |
| Crisp Rice | 13 |
| Almonds | 3.5 |
| Coconuts (medium) | 5.0 |
| Dextrose | 2.0 |
| Fructose | 11.0 |
| Brown sugar | 1.0 |
| Salt | 0.3 |
| Vanilla extract | 0.2 |
| Glycerine | 2.0 |
| Shortening | 6.0 |
| Real chocolate chips (4000 ct.) | 9.0 |
| Erythritol | 13.0 |

The erythritol, dextrose, fructose, and brown sugar were mixed with water to form the low calorie humectant of the present invention. After the humectant is formed, the other components are added and the formulation is baked to form a finished Granola bar. The fructose in this example is a high fructose corn syrup which contained about 42% fructose.

### EXAMPLE 5

This example illustrates making a brownie in conventional manner using the low calorie humectant of the present invention. The formulation of the brownie is shown in Table V below.

TABLE V

| Ingredients | Amount, percent |
|---|---|
| Sugar | 22.4 |
| Cake Flour | 21 |
| Bread Flour | 5.5 |
| Shortening | 7.0 |
| Cocoa | 16.0 |
| Non-fat Dry Milk | 2.5 |
| Whole Egg Solids | 2.0 |
| Salt | 0.8 |
| B.P.PYRO (Stauffer) | 0.2 |
| Soda | 0.1 |
| International Brand V Flavor | 0.1 |
| Erythritol | 22.4 |

The erythritol and sugar are mixed with water to form the low calorie humectant of the present invention (50% erythritol). After forming the humectant of the present invention, the other ingredients were added to the humectant and then baked in a conventional manner to form a baked good in accordance with the present invention.

It will be understood that the claims are intended to cover all changes and modifications of the preferred embodiments of the invention herein chosen for the purpose of illustration which do not constitute a departure from the spirit and scope of the invention.

What is claimed is:

1. A low calorie humectant composition comprising erythritol, one or more humectants, and water.

2. The composition of claim 1 wherein said erythritol and said humectants are present in a weight ratio of 1:1.

3. The composition of claim 1 wherein said humectants are selected from the group consisting of glycerol, propylene glycerol, fructose, sucrose, dextrose, high fructose corn syrup, and other polyols.

4. A method for increasing water retention properties of a humectant comprising combining with a humectant erythritol and water to form a blend.

5. A method for providing humectant properties to erythritol comprising combining erythritol with one or more low molecular weight carbohydrates and water to form a blend.

6. A food product formed from a food formulation having as an essential ingredient therein a low calorie humectant comprising erythritol, one or more humectants and water.

7. A food product formed from a food formulation wherein one of the ingredients in the food formulation is a low molecular weight carbohydrate and having as an essential ingredient therein a low molecular weight humectant formed from blending said low molecular weight carbohydrate with erythritol and water prior to combining the other ingredients in the food formulation to form said food product.

8. A method for forming a food product comprising:
(a) combining one or more humectants, erythritol and water to form a low calorie humectant; and
(b) combining said low calorie humectant with other ingredients to form said food product.

9. A method for increasing the shelf life of a baked good containing a low molecular weight carbohydrate comprising:
(a) combining erythritol with water and said low molecular/weight carbohydrate to form a low molecular weight humectant;
(b) combining said low molecular weight humectant with the other ingredients of said baked good to form a dough; and
(c) baking said dough to form said baked good.

10. A method for increasing the water retention properties of a baked good having a low molecular weight carbohydrate comprising:
(a) combining erythritol with water and said low molecular weight carbohydrate to form a low molecular weight humectant;
(b) combining said low molecular weight humectant with the other ingredients of said baked good to form a dough; and
(c) baking said dough to form said baked good.
